(19) United States
(12) Patent Application Publication
(10) Pub. No.: US 2008/0038073 A1
(43) Pub. Date: Feb. 14, 2008

(54) Interchangeable power source for hand-controlled apparatus, and system of functional attachments

(76) Inventor: Joseph James Paolicelli, Holbrook, NY (US)

Correspondence Address: John F. Vodopia, Esq., 3 Lone Oak Drive, Centerport, NY, 11721, US

(21) Appl. No.: 11/503,794

(22) Filed: Aug. 14, 2006

(51) Int. Cl. B23B 39/00

(52) U.S. Cl. 408/99

(57) ABSTRACT

The inventions include a two- or four-cycle internal combustion engine constructed with a simple inventive coupling, and coupling drive mechanism, which provides for a combined engine, coupling and coupling drive mechanisms in an inventive form of a hand-held power source. In a broader form, the inventions include the portable power source and a system of couplingably attachable manually-controlled, e.g., hand-held, drive assemblies and toolheads, which when coupled to the power source is driven at the attachments first means for receiving mechanical energy from the crankshaft. Functional attachment may include structure into which the power sources are inserted or mounted to drive. The functional attachments are hand-held power tools but for the power source, and include reciprocal coupling mechanism for mating with power source coupling mechanisms.

### BACKGROUND OF THE INVENTION

1. Field of the Invention

The present invention relates to gas powered hand-controlled apparatus and tools used by yardspersons, construction workers, home owners, landscapers, emergency response workers, etc. More particularly, the inventions set forth and described herein are directed to a portable interchangeable power source for powering a plurality of hand-controlled outdoor yard equipment, power tools and apparatus, etc., modified in accord with the inventive principles set forth herein.

2. Description of the Related Art

Various hand-held or manually operated, gas powered tools and apparatus are known. For example, gas-powered trimmers are known to comprise a guide tube having an inwardly disposed drive shaft, whereby provided at one end of the guide tube is a tool head having a rotatably driveable cutting tool, and provided at the opposite end of the guide tube is a drive motor for the cutting tool. US pending application No. 2003/0192189 to Hoche (“Hoche”) teaches an improvement to a trimmer. In particular, the Hoche trimmer includes an improved trimmer tool head that includes a gear mechanism housing and rotatably drivable tool shaft that is mounted in the housing and on which is held a hub portion that rotates with the tool shaft. On that side that faces the hub portion, the tool head is provided with at least one stripping edge, which has a radial component that extends from the inside to the outside, and that project beyond the contour of the hub portion.

Portable hand-held work apparatus such as motor-driven chainsaws, brushcutters, suction/blower apparatus and the like are typically manufactured to be light and easily manipulable in order that they can be easily carried and guided. Internal combustion engines which exhibit high drive and low structural volume, for a given piston displacement are preferred for such devices and apparatus. US Published Pending patent application No. 2005/0205043 to Schmidt, et al. (“Schmidt”) discloses a crankshaft assembly for use in combustion engines for driving the aforementioned handheld devices and apparatus. Schmidt assert that their crankshaft displays “good” centrifugal mass characteristics while provide a reduced structural space or volume for the engine comprising same.

US Pending patent application No. 2006/0137653 to Amend, et al. (“Amend”) discloses a manually guided instrument with internal combustion engine with a carburetor that is actuable by a throttle lever arrangement, which includes a throttle lever that is mounted in the implement so as to be pivotable about a pivot axis, and also includes a transmission element that operatively connects the throttle lever with the carburetor. The transmission element comprises a rigid connecting rod that is mounted on the throttle lever with the carburetor and on an actuating lever of the carburetor.

US Pending patent application No. 2003/0178211 to Uhl (“Uhl”) discloses a portable drill with an internal combustion engine that displays a shiftable gear mechanism. The gear mechanism has an output shaft for driving a tool. An input shaft of the gear mechanism is driven by a crankshaft. The gear mechanism is provided with a neutral speed or gear setting in which the output shaft is uncoupled from the input shaft. The neutral speed or gear setting is provided in the gear mechanism to enable restarting of the internal combustion engine, in instances where restart is necessary. Because drills and the like can become “stuck,” causing the internal combustion engine to quit or stop operation, the Uhl patent teaches that a lack of coupling in neutral removes the load from the restarting engine.

US Pending patent application No. 2002/0148701 to Nickel (“Nickel”) discloses a centrifuigal clutch for manually-guided motor driven implements such as chain saws and like hand-held devices. The clutch comprises centrifugal bodies, each of which comprises a shoe with the shape of a circular arc, and a support member. The shoes are held and guided by a guide on a carrier member that is disposed on the drive side. On the output side, the clutch is formed of a drum having a surface that axially and radially spans the centrifugal bodies. Disposed at each end of a centrifugal body is a projection and a complementary recess, which both extend approximately tangentially relative to the drum. The construction provides the centrifugal clutch with its ability to disengage or disconnect the engine drive mechanism from the mechanism which mates with it in the tool or functional attachment.

US patent application Ser. No. 2005/0138776 to Guip. et al. (“Giup”) discloses a tubular handle for a manually guided implement such as a power saw, including an essentially circular cross-section and at least one mounting portion for fixing the handle to the implement. In the area of the mounting portion, the circular cross-section is flattened to form a substantially planar abutment portion, beyond which a circular cross-section portion is retained. The abutment portion is provided for fixing the tubular handle to the implement.

US patent application No. 2006/0107534 to Menzel, et al. (“Menzel”) discloses a portable handheld work apparatus that suppresses motor vibrations. The suppressor is necessary for some internal combustion engine driven tools because single piston designs typically run somewhat rough and are burdened therefore with vibration. The vibrations from the engine end of a hand-held apparatus can cause tool oscillations that are noticeable in the handle. The Menzel invention is said to be a vibration suppressor which is much improved over its prior art vibration suppressors such that the suppressive effects are felt over a large operating parameter.

Much of the above-mentioned art is related to Stihl, Inc., which publishes data about their products online. Stihl, for example, provides specific information describing in detail Stihl's new Stihl 4-MIX® engine and brushcutter (FS 90) and trimmer (FS 90) at http:///www.stihlusa.com/pressoffice/march06 FS90.html. The tools allow for conversion if a buyer purchases optional gearbox attachments. That is, if a buyer purchases additional gearbox attachments that “convert” the Stihl FS 90 and FS 90 R into multi-task landscaping tools including the FH Power scythe, HT pole pruner, FC edger, BF mini-Cultivator, HL 0 Hedge Trimmer, HL 135 Hedge Trimmer, KW Stihl Power Sweep or KB Bristle Brush. The Stihl suggests that its 4-MIX engine provides increased power and torque to such hand-held implements. Stihl's products include and FS 130 brushcutter and FS 130 R trimmer, which include standard Stihl line heads. Stihl provides optional gearbox attachments to convert the powerheads into other landscaping tools into its FH Power Scythe, HT Pole Pruner, FC Lawn Edger, BF Minicultivator, HL Hedge Trimmers and KW PowerSweep.

Today, Stihl is a forerunner in both the technology utilized in hand-held, power-driven yard or landscape apparatus, and in the US marketplace. And while the versatility of the 4-MIX driven trimmers and brushcutters is applaudable, the construction severely limits versatility of attachments, and simplicity and elegance as a product in the marketplace. That is, the conversions first require purchase of the additional optional interchangeable gearbox components and then limit the number of possible attachments. Additional purchases are costly to the consumer. One of the most difficult tasks for such lawn or yard tool designers is to minimize cost and improve versatility, reduce maintenance without minimizing the aggregate quality of the product. These characteristics along with power output, physical weight and handleability are factors which contribute to a yard tool's aggregate quality. A system that includes a single power source adapted to be coupled into any number of traditional hand-held, gas power apparatus and tools, the apparatus and tools arranged with a mating coupler to receive the power source would be welcomed in the marketplace, where the consume can purchase the power source, and any of the available modified hand-controlled apparatus and tools.

### SUMMARY OF THE INVENTION

To that end, the inventions disclosed and described herein include a two- or four-cycle internal combustion engine constructed with a simple inventive coupler so that it may be used interchangeably to drive any of a plurality of hand-controlled tools and apparatus modified to include a mating coupler. When the power source is connected through its coupler to the mating coupler on the inventive hand-controlled tools and apparatus, various links from the power source to the apparatus and from the apparatus to the power source are accommodated through the couplers.

The more broadly claimed inventions include, such as those set forth in the claims appended hereto, a portable, light-weight power source, the power source arranged for coupling into any one of similarly-adapted couplingly attachable and manually-controlled tool or apparatus drive assemblies and the toolheads driven thereby. As used hereinafter, the term functional attachment, and its forms, will be used to describe the hand-controlled implements driven by the inventive interchangeable power source, as modified to include the coupler, and its requirements, or the hand-controlled vehicles or structures into which the power sources are inserted or mounted. The functional attachments are hand-held power tools but for the power source. The functional attachments include an inventive couplings, arranged to mate with the coupling in the power source, connected to for example in a case of a trimmer-type hand-held power tool, the tool's guide tube with shaft and gear mechanisms, which typically includes what is traditionally recognized as a toolhead.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a schematic diagram showing a power source 100 of this invention;

FIG. 2 is a schematic diagram of “top” portion 200 of a manually operated or manually controlled outdoor tool, or functional apparatus;

FIG. 3 depicts a throttle control mechanism utilized in the inventive designs;

FIG. 4 is a more detailed version of the linkage shown in the FIG. 3;

FIG. 5 is a detailed view of a coupling for functional apparatus constructed to accommodate a throttle mechanism, constructed in accord with the present invention;

FIG. 6 depicts a weed whacker functional apparatus, 600, with inventive coupler 610;

FIG. 7 depicts a hedge trimmer functional apparatus, 700, with inventive coupler 710;

FIG. 8 depicts a chainsaw functional apparatus, 800, with inventive coupler 810; and

FIG. 9 depicts a lawn mower functional apparatus, 900, with inventive coupler 810.

### DETAILED DESCRIPTION OF THE PREFERRED EMBODIMENTS OF THE INVENTION

The portable interchangeable power source of the invention (“power source”) includes an internal combustion engine, a universal drive or power train system and a coupling mechanism arranged to couple mechanical power delivered by the drive mechanism to any of the inventive hand-controlled equipment or attachments, constructed to operatively couple with the power source, and like apparatus and systems so modified. The functional attachments may include various known and conventional tool heads, or tool head attachments, which might be otherwise conventional but for inclusion of the inventive coupling, and any modifications required for inclusion of the coupling in the accessory or functional attachment. Examples of hand-controlled equipment and apparatus which may be modified in accord with the invention include chain saws, hedge trimmers, blowers, lawn mowers, rotary devices, weed-trimmers, portable air conditioners, minibikes, go carts, compressors, etc. The list is not exhaustive, but is meant to show that any conventional hand-controlled power tool, outdoor yard implement, etc., any be modified to operate in accord with the present invention.

Each inventive hand-controlled functional attachments or implements include a mating coupler, or coupling means, such that the interchangeable power source can be readily interchanged between the inventive implements and apparatus, connecting all necessary links between the body of the apparatus and the power source via the mating couplers. The inventive coupling essentially couples, or links the internal combustion engine to top of the drive chain of the functional attachment. The coupler on the functional attachment mates with the coupler on the interchangeable power source when the power source is connected to the attachment. For example, the speed control from the attachment is coupled to the power source and the crankshaft energy from the internal combustion engine comprising the power source. The crankshaft energy is modified by gear ratios and known drive mechanisms, and delivered through the mating couplers to the initial drive portion of the drive chain at the functional attachment. The planetary gears to drive the functional attachments provide that the drive energy is modified to meet the attachment's needs, as mentioned, for example, specific torque requirements, RPM requirements, etc. A centrifugal clutch, not shown in any of the drawings, throttle mechanism, vibration suppressor, etc., may be incorporated into the several embodiments, and is readily provided for in the inventive designs.

The system of the invention includes the portable inventive power source with coupler coupled through a like-constructed mating coupler to the complementary functional attachments. The ability to simply move the power source between functional attachments, couple it into a particular functional attachment, is very desirable to the consumer not only for ease of use, but they benefit from having to purchase only one gas powered source to drive a plurality of power tools and outdoor gas-powered equipment, modified in accordance with the inventive principles herein to couple and be driven by the portable power source. That is, the power source may be sold with numerous functional attachments so designed, as a combination, where the purchaser can realize the benefit of an assortment of power driven tools for much less cost than purchasing each of the tools separately, with separate internal combustion engines for each. Because the power source for the assortment of functional attachments is universal to the bunch, the manufacturability of attachment is only different with respect to the top of the drive chain at the coupler, for example, the throttle and drive attachments.

While the inventions as described herein are directed to internal combustion engines, the skilled artisan shall readily understand that the inventive concepts may be readily applied to electrically operated, e.g., battery-powered, hand-held, or hand- operated outdoor tools and apparatus, without deviating from the scope and spirit of the invention. It is the driving versatility of the inventive power source, as a universal driver for coupling attachment, to drive each of an array of functional attachments that include most known manually controlled and hand-held tools, so modified. The interchangeable power source 's simple, compact, portable construction, and its ability to mate and deliver driving force to the functional attachments through the inventive coupling arrangement, that renders the system of the inventions herein valuable, and desirable to consumers in need of related functional equipment and tools.

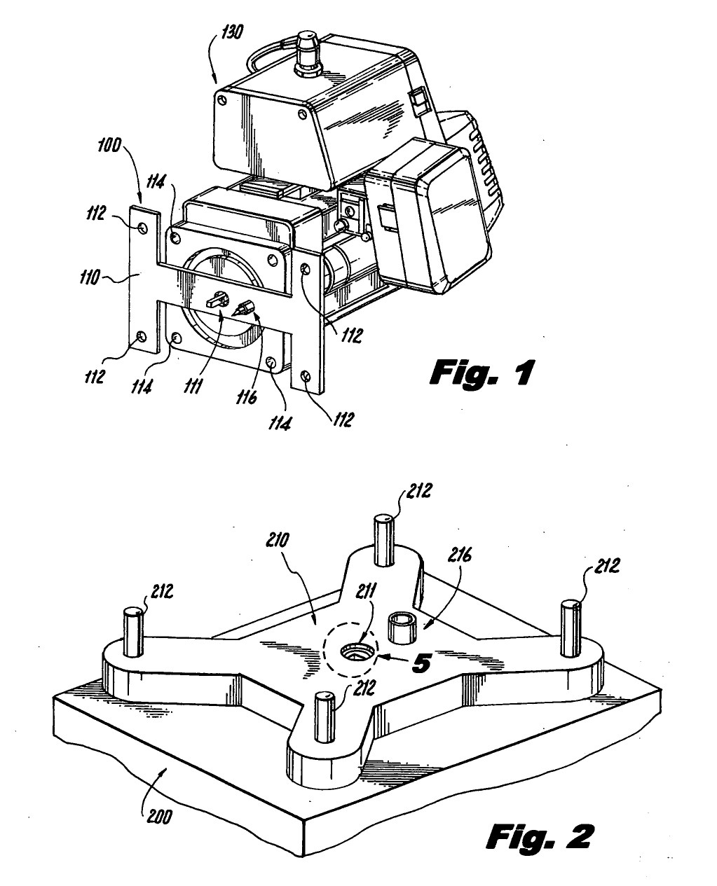

FIG. 1 is a schematic diagram showing a power source 100 of this invention. The reader should note that the figures, and explanations thereof, are presented for exemplary purposes only. The specific embodiments shown are not meant to limit the scope and spirit of the invention in any way or form. Power source 100 includes an internal combustion engine, or like 130, and a power source coupler, or coupler 110. The coupler 110 includes various vias to accord communication, mechanical or otherwise, through the power source coupler. For example, via 111 as shown in FIG. 1 provides for coupling of mechanical drive energy from a crankshaft of the internal combustion engine (the crankshaft behind the coupler in the FIG. 1 perspective, but not shown explicitly). Vias 112 allow the power source 100 to be fixed, or couplingly attached by the coupler 110 to a mating coupler comprising a functional apparatus (see FIG. 2). As an example, vias 112 in the power source coupler 110 may comprise pins for attachably insertion into vias 212 of a functional coupler 212, fixing the power source to the attachment. Vias 114 and 116 allow for communication between a functional attachment and motor 130, within power source 100.

FIG. 2 is a schematic diagram that highlights a coupler 210 of the invention, fixed to a “top” portion 200 of a manually operated or manually controlled outdoor tool, or apparatus (not identified in its entirety in the figure), so modified to utilize coupler 210 to allow the attachment to receive, and have the power source 100 power and control same while coupled. The figure is provided to highlight that the inventive coupler 210 couples to coupler 110 operatingly interface the attachment and power source at or near the top of the mechanical drive chain of the functional attachment. The attachment coupler 210 includes via 211 to provide communication of mechanical energy from a power source to the drive mechanism and gears of the functional apparatus. Vias 212, or the like, are included for mounting the coupler 210 to the mating coupler 110. Vias 214 and 216 are shown for use in communication between the functional apparatus and power source. The use of any particular via for any functional use, such as attaching, communicating drive energy, communicating control information, etc., is not meant to be a limitation on any embodiments of the invention, exemplified or covered by the claims appended hereto. Optional use of such vias or other means for communicating between the couplers should be clear to the skilled designer or artisan.

FIG. 3 depicts an exploded view of a throttle control mechanism 300 of the present invention. The control mechanism is modified so the portions resident in the fimctional attachment functionally communicate with a power source, through a via 214 used for that purpose. The via in coupler 210 is arranged or constructed to receive piston 320 from the engine power drive mechanism, through power source coupler 110 via arrangement 114. The throttle control communication is exchanged through respective vias, or the respective couplers to drive a carburetor of the power source (not explicitly shown in FIG. 1). The functional attachment includes, arranged behind the coupler (not shown), a throttle control mechanism or means that terminates at a piston 335. Piston 320 (extending through via 114) is driven by piston 335 to control throttle, etc., whereby when a detachable power source such as source 100 is connected through its coupler 110 through coupler 210 of a functional apparatus, extensions of piston 320 contacts pushes piston 335 of the functional apparatus (spring not shown), completing the linkage between the throttle control on the apparatus and the carburetor. More particularly, the piston 335 drives linkage 360 to drive a pivotal butterfly valve 350, which controls the carburetor 345 for the power source 100. An air intake 355 to the carburetor is shown. A throttle trigger, or hand-actuated throttle control 330, pushes on a rotatable disc 325 which pushes on piston 214, which through the couplers pushes on piston 320 to control the carburetor. Disc 325 is preferably constructed with graduated thicknesses to assert the push on the controller piston 335.

FIG. 4 is a more detailed version of the linkage shown in the FIG. 3, viewed from a perspective looking from the tool portion of the functional apparatus to the power source. As is seen from the figure, coupler 210 includes rotating disc 325, on one side (facing the tool) and via 214 with piston 335 on its other face. As mentioned, the thickness of the disc is graduated in order to effectively push its piston to contact mating piston 320, shown extended out of via 114. Via 114 connects the control from the users contact with lever 330 through linkage 360 to carburetor 345.

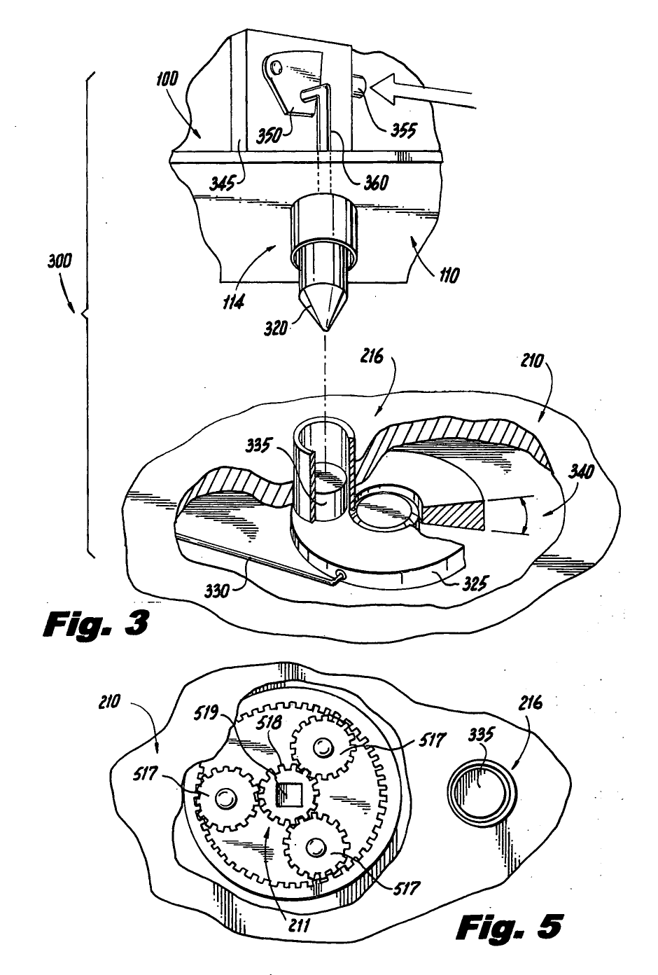

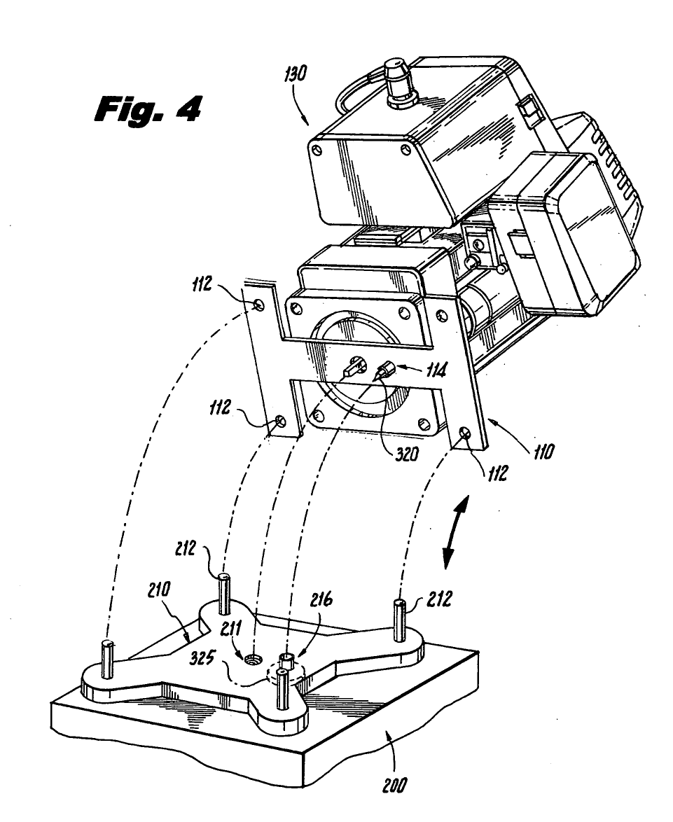

FIG. 5 is a detailed view of a coupler 200 for functional apparatus constructed to accommodate a throttle mechanism, and a drive mechanism, which extends from a power source through a via 111, through a via 211 on the coupler, to drive the functional apparatus. As seen through via 211, the drive mechanism of the functional apparatus includes one or more planetary gears 517, and a drive connect means 518 with shaft 519 which detachably connects to a crankshaft drive mechanism of the engine of the power source, through via 111, when the power source is inserted into the functional apparatus. The figure also shows the throttle via, or cylinder, as described.

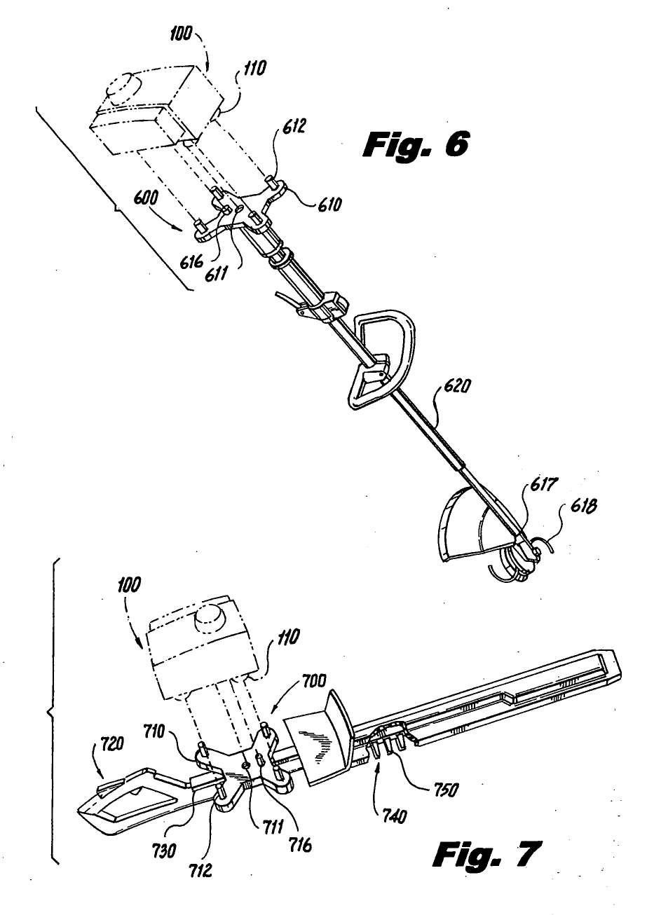

FIG. 6 depicts a weed trimmer functional apparatus, 600, with inventive coupler 610. Inventive coupler 610 may connect to a mating coupler of a power source such as coupler 110 of power source 100 with any means known to the skilled artisan for accomplishing such fixation. In an example, coupler 610 includes vias, e.g., pins or pin receptacles 612. Where the functional vias 112 may be implemented with a pin/pin-receptacle arrangement, the fixation means, or location within the couplers of communications vias are not meant to limit the scope and spirit of the invention in any way, but merely to support the detachable coupling, and operational coupling between the power source and attachment. The functional apparatus or attachment 600 includes a tube 620 with internal drive shaft and gear mechanisms (see FIG. 5). Vias 614 and 616, in the embodiment shown, are openings that allow delivery of functional or operational communication between the power source and attachment, i.e., torque, power, etc. For example, drive energy is communicated through any gear mechanism to the drive shaft mechanism, to deliver rotational force at axle 617, to generate the cutting force in cutting implements 618.

In a variation on the FIG. 6 embodiment, the functional attachment provides information, whether it be via an electrical communication signal, or some other form of communication, such as direct mechanical communication, back to the power source to control drive characteristics for the particularly arranged functional attachment. For example, a signal, electrical or mechanical, is sent by the attachment to the power source through respective mating couplers, and, for example. Resulting in an adjustment of torque, speed, operation states (e.g., disengage power train from crankshaft), etc.

FIG. 7 depicts a hedge trimmer finctional apparatus or attachment, 700, with inventive coupler 710. Inventive coupler 710 provides various attachment means, such as vias 712, by which the coupler is affixed to a mating coupler, such as coupler 110 of the power source 100 shown in FIG. 1. The power source slips into and couples with the functional attachment 700. The functional apparatus or attachment 700 includes a handle 720, and housing 730, which houses drive and gear mechanisms, attached to the engine crankshaft, such as clutches (not shown in detail). A vibrating means 740 is connected to the gear mechanism, which when in operational mode, vibrates clipper elements 750. Vias 714 and 716, in the embodiment shown, are included as opening to facilitate delivery of mechanical energy, etc., to the gear mechanism to the power the elements, and cut.

In a variation on the FIG. 7 embodiment, the functional attachment 700 provides information, whether it be a via 714 or 716 including an electrical wire, or by some other communication back through the coupler 710, to the power source. This may be implemented by physical or electrical means. The portable power source, such as source 100 of FIG. 1, includes a coupler modified to complement the vias to receive said feedback, and adjust cyclical speed, power delivered, operation states (e.g., disengage power train from crankshaft), etc., and direct said information to a control mechanism in the power source which is responsive thereto (not shown). The control mechanism may be mechanical, or electrical, where control logic to control the operation in accord with the signals is implemented in an ASIC, or other control device.

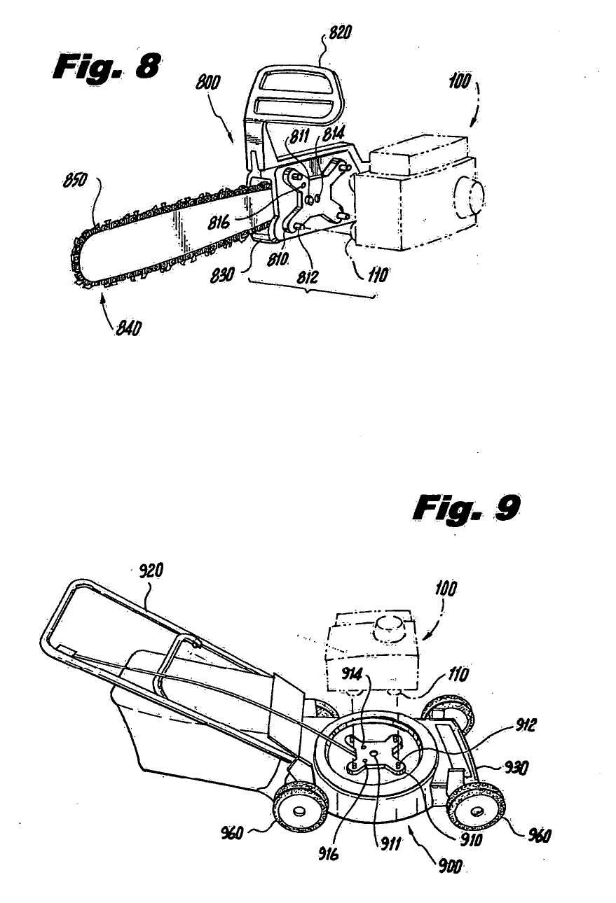

FIG. 8 depicts a chainsaw functional attachment or apparatus, 800, with inventive coupler 810. Inventive coupler 810 provides various attachment means, such as vias 812, by which the coupler is affixed to a mating coupler, such as coupler 110 of the power source 100 shown in FIG. 1. The functional apparatus 800 includes a handle 820, and housing 830, which includes gear mechanisms, such as clutches, load balancers, etc., not shown in detail. A blade mechanism 840 is connected to the gear mechanism, which when in operational mode, rotates chain mechanism 850. Vias 814 and 816, in the embodiment shown, are used to deliver mechanical energy through the gear mechanism to power the blade and chain mechanisms. The embodiment may comprise a vibration suppressor for smooth operation.

FIG. 9 depicts a lawn mower functional attachment or apparatus, 900, with inventive coupler 910. Inventive coupler 910 provides for various attachment means to couple the coupler, such as vias 912, by which the coupler is affixed to a mating coupler, such as coupler 110 of the power source 100 shown in FIG. 1. The functional attachment or lawn mower modified in accordance hereto includes a handle 920, attached to lawnmower housing 930. Housing 930 supports a power housing 935, upon which includes gear mechanisms, such as clutches, etc. (not shown in detail) which are directly driven through the coupling by the power source drive energy. The housing 930 is attached to wheels 960 for user mobility. As mentioned, the drive chain delivers the mechanical power received from the source to a shaft rotating a cutter blade (not shown in this view). Vias 914 and 916, in the embodiment shown, are used to deliver mechanical or electrical communication signals between the inventive power source and attachments, for example, to compel the hand-operated or hand-controlled attachment to cut the lawn.

As mentioned above, the embodiments shown and described herein are included to provide examples of the broad applications to which the inventive concepts may be applied, but are meant in no way to limit the invention, or the claims set forth below.

What is claimed is:

1. A manually-operated multitasking power tool system includes an internal combustion engine constructed to include a complementary coupling mechanism to couple the system power source and required links to various functional attachments modified to receive the system power source, the multitasking hand-controlled power tool system comprising:
a power source comprising a two- or four-cycle internal combustion engine constructed to accommodate power and control needs of functional attachments into which the power source is coupled into, the power source including a coupler that allows attachment to and communication with the functional attachments; and
one or more functional attachments constructed with a coupler arranged to mate with the power source coupler, wherein the mating couplers provide for communication of mechanical drive energy from the power source to a drive chain within the functional apparatus, and from a throttle control in the functional attachments to drive a carburetor in the internal combustion engine.

2. The system as set forth in claims 1, wherein the functional attachments attach as close as physical limitations allow to the crankshaft of the engine therein.

3. The system as set forth in claim 1, wherein the drive chain in the functional attachments includes a mechanical drive system arranged to communicate with the power source drive system though the mating complementary couplers, and means for driving the mechanical drive system.

4. The system as set forth in claim 1, wherein a centrifugal clutch is included as a drive mechanism in the power source, and the drive system in the functional apparatus is arranged to be driven thereby.

5. The system as set forth in claim 1, wherein the internal combustion engine includes a carburetor and includes a throttle lever arrangement for activating the carburetor where the throttle lever is mounted in the functional attachment to pivot about a pivot axis, and a transmission element that operatively connects the throttle lever through the couplers to said carburetor in the power source, wherein the transmission element is a connecting rod or other connecting means mounted on the throttle lever and on an actuating lever on the carburetor.

6. The system as set forth in claim 5, wherein an actuating section of said throttle lever is disposed between the pivot axis and a bearing point of the throttle lever for the connecting rod.

7. The system as set forth in claim 1, wherein the power source further comprises a vibration suppressor for suppressing vibrations occurring during operation of said power source and functional attachment, a drive motor to drive the suppressor, wherein the suppressor defines a rotational axis and including a suppression mass for generating an imbalance, the mass mounted at a radius to said rotational axis, and wherein the suppressor includes a mounting arrangement for mounting said mass such that its position changes with changing RPM.

8. The system as set forth in claim 1, wherein the functional attachment is a trimmer including the coupler, a gear mechanism housing, a rotatably driveable toll shaft that is mounted in said gear mechanism housing, and a hub portion that is held on, and rotates with, said tool shaft, wherein on a side that faces the hub portion the functional attachment is provided with at least one stripping edge, which has a radial component which extends from an inner region to an outer region, and which projects beyond a contour of said hub portion.

9. The system as set forth in claim 1, wherein the power source includes a handle comprising a tubular member with a circular cross-section and at least one mounting portion for fixing the tubular handle to the functional attachment, wherein in the are of the at least one mounting portion, the circular cross-section is flattened to form an at least approximately planar abutment portion, wherein beyond the abutment portion, a circular cross-sectional portion is retained, and wherein said abutment portion is provided for fixing the tubular handle to the implement.

10. The system as set forth in claim 1, wherein the functional attachment comprises a portable drill with coupler, and is constructed to include at least a shiftable gear mechanism with an output shaft for driving a toolhead of the functional attachment, and an input shaft that is driven by the crankshaft of the internal combustion engine comprising the power source with coupler, and wherein the gear mechanism includes a neutral gear stetting in which said output shaft is uncoupled from said input shaft.

11. The system as set forth in claim 1, wherein said power source includes a centrifugal clutch, the centrifugal clutch comprising:
a carrier member having an axis of rotation;
centrifugal bodies, each of which has a shoe that has a shape of a circular arc with two lateral ends, and, on a drive side of said centrifugal clutch, is movably held on said carrier member via a support member;
a drum disposed on an output side of the centrifugal clutch coaxial to an axis of rotation of the carrier member, wherein the drum spans the shoes, and wherein during centrifugal clutch operation, under the effect of centrifugal force, the shoes are engageable against a surface of the drum counter to a restoring force; and
a lateral guide to moveably interconnecting the centrifugal bodies and comprising, at each of the lateral ends of the shoes, a respective tangentially extending recess and projection, wherein in an assembled state of the centrifugal clutch, each projection extends into a recess of an adjacent one of said centrifugal bodies.
